(19) United States
(12) Patent Application Publication
(10) Pub. No.: US 2026/0289631 A1
(43) Pub. Date: Sep. 24, 2026

(54) ARTIFICIAL INTELLIGENCE (AI)-BASED SEARCH RESULTS

(71) Applicant: eBay Inc., San Jose, CA (US)

(72) Inventors: Rahul Ajaykumar Agarwal, Santa Clara, CA (US); Seyyed Hadi Hashemi, Amstelveen (NL); Christian Klaus Herold, Aachen (DE); Michael Damian Kozielski, Aachen (DE); Amir Zandieh, Freienbach (CH)

(73) Assignee: eBay Inc., San Jose, CA (US)

(21) Appl. No.: 19/087,088

(22) Filed: Mar. 21, 2025

(51) Int. Cl. G06Q 30/0601

(52) U.S. Cl. CPC G06Q 30/0627; G06Q 30/0619; G06Q 30/0641

(57) ABSTRACT

An artificial-intelligence (AI)-based system for generating search results is described. The system may receive a search query from a user device, the search query associated with an item on an online marketplace. The system may obtain a set of search results including one or more items that correspond to the search query based on the search query. The set of search results may also be provided to a large language model (LLM). The system may receive a prompt for the LLM from the LLM based on the set of search results. Based on the prompt, the system may execute the LLM to generate a subset of the one or more items based on information associated with the items and data associated with the online marketplace.

### BACKGROUND

Online marketplaces support and thus experience numerous and varied activities that facilitate transactions on the online marketplace. Some such activities may include a user (e.g., seller) posting a listing of an item for sale, where the listing may include a description and other information about the item, and another user (e.g., buyer) searching for items to purchase. After performing a keyword search for a specific item or category of items, the buyer may be presented with a long list of items. The buyer may filter the list of items (e.g., by price, condition, and so forth), however such filtering may be limited based on what information sellers provide in item listings. In addition, buyers may manually read individual item descriptions to ascertain specific information about items they are interested in.

### SUMMARY

Artificial intelligence (AI)-based search results are leveraged with an online marketplace. In one or more implementations, a user (e.g., a buyer) may type a search query into a search field on an online marketplace to look for items to purchase. The search query may include a keyword or another natural language string related to the items. As a result, the buyer may be provided with a list of items that match the search query, including hundreds or thousands of items in some cases. Such search results may also be provided to an AI platform, such as a large language model (LLM), which may be trained on a set of data that includes item listings on the online marketplace. That is, the LLM may be trained on item descriptions and any other item information provided by a seller when listing an item for sale. Instead of filtering the search results according to preset parameters, the buyer may query the LLM with specific questions about the search results via the same user interface as the search field. By way of example, the buyer may type a question to a chatbot to refine the search results (e.g., the user may ask for listings that offer Priority Mail shipping). The LLM (e.g., through the chatbot) may generate and display an output of a response to the buyer's question. In some cases, the LLM may generate a subset of the search results including one or more item listings that satisfy the buyer's question (e.g., the subset of search results may all offer Priority Mail shipping). In this way, the LLM may provide more specific and more accurate results to the buyer than generic filtration.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a search platform in accordance with aspects of the present disclosure.

FIG. 3 depicts an example of a user interface in accordance with aspects of the present disclosure.

FIG. 4 depicts a procedure in an example implementation of AI-based search results in accordance with the aspects of the present disclosure.

FIG. 5 illustrates an example of a system that includes an example computing device that is representative of one or more computing systems and/or devices that may implement the various techniques described herein.

### DETAILED DESCRIPTION

### Overview

An AI-based system for generating and refining search results for an online marketplace is described. In accordance with the described techniques, items may be available (e.g., listed) for sale on the online marketplace. The online marketplace may be accessible by decentralized computing devices that correspond to “clients” of the online marketplace, e.g., users that have accounts with the online marketplace. Users of the online marketplace may have some control over which items they list with or purchase from the online marketplace. For example, the users may determine when to list or purchase items, and may do so from different locations via a website or mobile application for the online marketplace. When a seller posts a product listing for sale, the seller may include information about the product such as a title, a description, and any other relevant information they choose to include.

To search for items on the online marketplace, a buyer may type keywords or some other natural language query into a search field. As a result, the buyer may be provided with a large list of item listings that correspond to the search query, which may include hundreds or thousands of listings. Such search results may be difficult for the buyer to navigate for several reasons. First, information about each item that may be relevant to the buyer (e.g., shipping information) may be hidden within an item description. The item description may only be viewed if the buyer clicks on the listing, which may open in a separate tab or window. Manually reading individual item descriptions may be time consuming and complicated for the buyer, particularly if the buyer wants to compare several listings to each other.

Some buyers may attempt to filter their search results using preset filter parameters, such as price, condition, availability, or other parameters. Current filtering functionality is based on categorical or range-based filters, which are based on pre-defined, specific criteria. However, such filtering functionality is based on the information sellers include in specific fields of item listings, which may be incomplete and incorrect. That is, instead of listing shipping information in a specific “shipping information” field, a seller may write out their shipping policies in an item description. This may result in inaccurate search results, slow processing, and inefficient data retrieval. For example, if a buyer filters their search results to only include items in a “new” condition, the resulting item listings may exclude listings that did not include any information about the condition (e.g., because the seller left the information out of the listing), even if the excluded listings actually offer new items. Moreover, current systems lack the ability to narrow down the search results based on image information in an item listing. This may result in buyers missing out on items that better suit their needs if the corresponding item descriptions lack information, and sellers losing sales of items that are not being properly filtered in searches.

To address these limitations, techniques for generating AI-based search results are described. In one or more implementations, the described techniques involve an AI platform, including an LLM, implemented as part of an online marketplace. The LLM may be capable of receiving long-context inputs to answer users'questions about item listings they search for. Specifically, a user (e.g., a buyer) may type a search query into a search field on an online marketplace to look for items to purchase. The search query may include a keyword or another natural language string related to the items.

As a result, the buyer may be provided with a list of items that match the search query, including hundreds or thousands of items in some cases. Such search results may also be provided to an AI platform, such as an LLM, which may be trained on a set of data that includes item listings on the online marketplace (e.g., item descriptions and any other item information provided by a seller when listing an item for sale), shipping protocols (e.g., global shipping data), collectables data (e.g., character names of characters on cards), and stock image identifiers compared to actual image identifiers. Instead of filtering the search results according to preset parameters, the buyer may query the LLM with specific questions about the search results via the same user interface as the search field. By way of example, the buyer may type a question to a chatbot or AI assistant to refine the search results (e.g., the user may ask for listings that offer Priority Mail shipping). The LLM (e.g., through the chatbot) may generate and display an output a response to the buyer's question. In some cases, the LLM may generate a subset of the search results including one or more item listings that satisfy the buyer's question (e.g., the subset of search results may all offer Priority Mail shipping). In this way, the LLM may provide more specific and more accurate results to the buyer than generic filtration.

The described techniques may result in several improvements, including faster processing, improved data storage and data retrieval efficiency, and enhanced graphical user interface (GUI) features, among other improvements. For example, the LLM may be designed to handle long-context inputs, which may result in faster processing and more efficient data retrieval. The LLM may also improve processing and data retrieval based on utilizing learned knowledge (e.g., being trained on significant amounts of data related to the e-commerce domain, including previous item listings) and in-context learning (e.g., using search results output based on a search query). The described techniques may improve data storage, efficiency, and accuracy by outputting refined search results using an LLM that is trained to answer queries about specific item information rather than filtering search results based on categorical or range-based filters, which are based on pre-defined, specific criteria. Additionally, the described techniques may also enhance the GUI of the online marketplace by providing users a platform to interact with a chatbot or AI assistant in the same window as their search rather than requiring the user to navigate filter menus and additional tabs.

In some aspects, the techniques described herein relate to a computer-implemented method including: receiving, from a user device, a search query associated with an item on an online marketplace; obtaining a set of search results including one or more items that correspond to the search query based on the search query; providing the set of search results to an LLM; receiving, from the user device, a prompt for the LLM based on the set of search results; and executing the LLM based on the prompt to generate a subset of the one or more items, wherein the subset of the one or more items is generated based on information associated with the one or more items and data associated with the online marketplace.

In some aspects, the techniques described herein relate to a computer-implemented method, wherein the prompt comprises a long-context input associated with the set of search results.

In some aspects, the techniques described herein relate to a computer-implemented method, wherein the prompt comprises a request to filter the one or more items based on one or more attributes, and wherein the subset of the one or more items is generated based on the request.

In some aspects, the techniques described herein relate to a computer-implemented method, wherein the prompt comprises a question regarding information associated with the one or more items that is excluded from one or more corresponding item listings, wherein the subset of the one or more items is generated based on the question.

In some aspects, the techniques described herein relate to a computer-implemented method, wherein the information associated with the one or more items comprises one or more item listings corresponding to the one or more items, an item listing comprising at least one of a title, a description, pricing information, and shipping information.

In some aspects, the techniques described herein relate to a computer-implemented method, wherein the data associated with the online marketplace comprises at least one of shipping procedures, image data, or specifications corresponding to an item number.

In some aspects, the techniques described herein relate to a computer-implemented further including providing one or more example prompts based on the search query, wherein the prompt is selected from the one or more example prompts.

In some aspects, the techniques described herein relate to a computer-implemented method further including displaying, via a user interface of the user device, the subset of the one or more items, wherein displaying the subset of the one or more items comprises highlighting the subset of the one or more items or outputting a list of the subset of the one or more items.

In some aspects, the techniques described herein relate to a computer-implemented method, wherein the prompt is associated with a portion of the set of search results highlighted by a user of the user device.

In some aspects, the techniques described herein relate to a computer-implemented method, further including receiving, from the user device, feedback associated with the subset of the one or more items, and generating a second subset of the one or more items based on the feedback.

In some aspects, the techniques described herein relate to a computer-implemented method, wherein the LLM is a multi-modal LLM with at least a text-analysis capability and an image-analysis capability.

In some aspects, the techniques described herein relate to a system including: one or more processors; and memory storing instructions that, when executed by the one or more processors, cause the system to: receive, from a user device, a search query associated with an item on an online marketplace; obtain a set of search results including one or more items that correspond to the search query based on the search query; provide the set of search results to an LLM; receive, from the user device, a prompt for the LLM based on the set of search results; and execute the LLM based on the prompt to generate a subset of the one or more items, wherein the subset of the one or more items is generated based on information associated with the one or more items and data associated with the online marketplace.

In some aspects, the techniques described herein relate to a system, wherein the prompt comprises a long-context input associated with the set of search results.

In some aspects, the techniques described herein relate to a system, wherein the prompt comprises a request to filter the one or more items based on one or more attributes, and wherein the subset of the one or more items is generated based on the request.

In some aspects, the techniques described herein relate to a system, wherein the prompt comprises a question regarding information associated with the one or more items that is excluded from one or more corresponding item listings, wherein the subset of the one or more items is generated based on the question.

In some aspects, the techniques described herein relate to a system, wherein the information associated with the one or more items comprises one or more item listings corresponding to the one or more items, an item listing comprising at least one of a title, a description, pricing information, and shipping information.

In some aspects, the techniques described herein relate to a system, wherein the data associated with the online marketplace comprises at least one of shipping procedures, image data, or specifications corresponding to an item number.

In some aspects, the techniques described herein relate to a system, wherein the instructions further cause the system to provide one or more example prompts based on the search query, wherein the prompt is selected from the one or more example prompts.

In some aspects, the techniques described herein relate to a system, wherein the instructions further cause the system to display, via a user interface of the user device, the subset of the one or more items, wherein displaying the subset of the one or more items comprises highlighting the subset of the one or more items or outputting a list of the subset of the one or more items.

In some aspects, the techniques described herein relate to a system, wherein the prompt is associated with a portion of the set of search results highlighted by a user of the user device.

In some aspects, the techniques described herein relate to a system, wherein the instructions further cause the system to receive, from the user device, feedback associated with the subset of the one or more items, and generating a second subset of the one or more items based on the feedback.

In some aspects, the techniques described herein relate to a system, wherein the LLM is a multi-modal LLM with at least a text-analysis capability and an image-analysis capability.

In some aspects, the techniques described herein relate to a non-transitory computer-readable media storing instructions that, when executed by one or more processors, cause the one or more processors to perform operations including: receiving, from a user device, a search query associated with an item on an online marketplace; obtaining a set of search results including one or more items that correspond to the search query based on the search query; providing the set of search results to an LLM; receiving, from the user device, a prompt for the LLM based on the set of search results; and executing the LLM based on the prompt to generate a subset of the one or more items, wherein the subset of the one or more items is generated based on information associated with the one or more items and data associated with the online marketplace.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

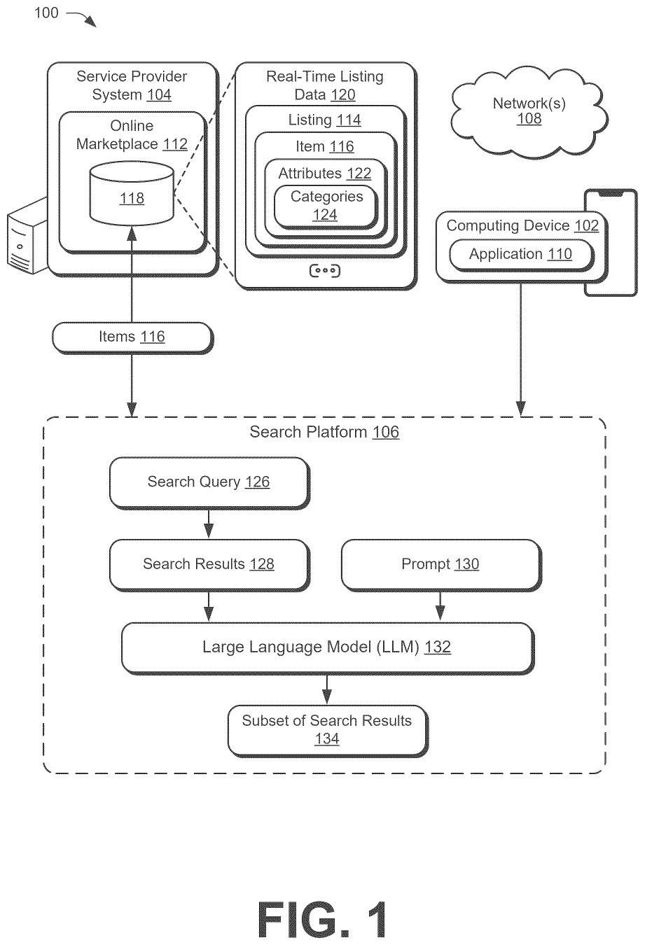

FIG. 1 is an illustration of an environment 100 in an example implementation that is operable to employ techniques described herein. The environment 100 includes a computing device 102, a service provider system 104, and a search platform 106. In one or more implementations, the computing device 102, the service provider system 104, and the search platform 106 are communicatively coupled, one to another, via network(s) 108. One example of the network(s) 108 is the Internet, although one or more of the computing device 102, the service provider system 104, and the search platform 106 may be communicatively coupled using one or more different connections or different networks in various implementations (e.g., a cloud).

Although the search platform 106 is depicted in the environment 100 as being separate from the computing device 102 and the service provider system 104, in one or more implementations, an entirety or various portions of the search platform 106 are implemented at or by the computing device 102 and/or the service provider system 104. In at least one implementation, for example, at least a portion of the search platform 106 is implemented by an application 110 of the computing device 102 and/or using various resources of the computing device 102, such as hardware resources, an operating system, firmware, and so forth. Additionally, or alternatively, at least a portion of the search platform 106 is implemented by resources (e.g., server-based storage, processing, and so on) of the service provider system 104. Additionally, or alternatively, at least a portion of the search platform 106 is implemented using a third-party service, such as a web services platform that provides one or more hardware and/or other computing resources to support provision of services by web service providers.

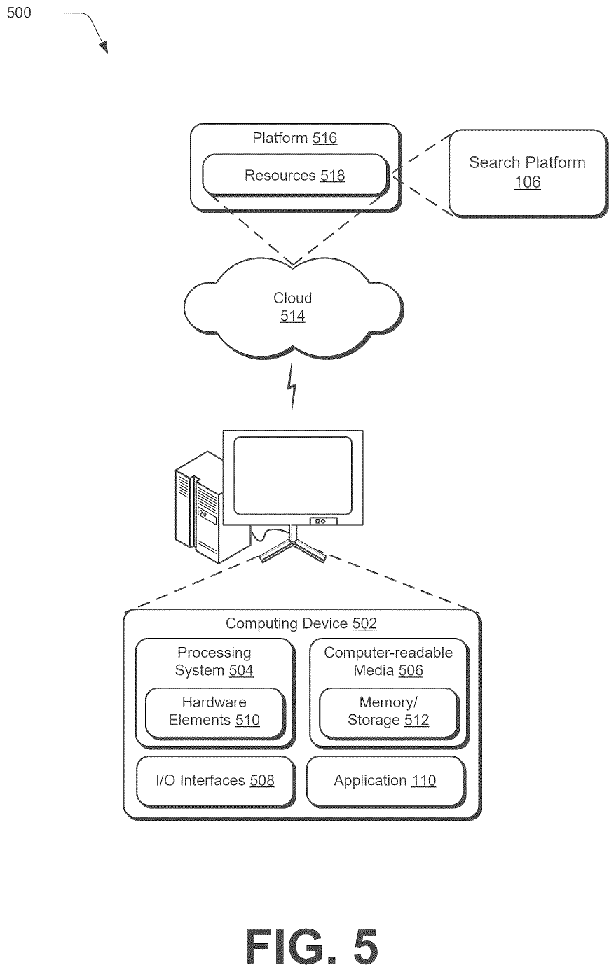

Computing devices that implement the environment 100 are configurable in a variety of ways. A computing device (e.g., computing device 102), for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 5.

In at least one implementation, the application 110 supports communication of data across the network(s) 108, such as between the computing device 102 and the service provider system 104 and/or between the computing device 102 and the search platform 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112 and/or search platform 106. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, facilitate user interaction with web pages of the online marketplace 112's website, and search for listings, items, and/or functionality of the online marketplace 112. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 114 for items 116 and to expose those listings 114 (e.g., publish them) across the network(s) 108 to one or more computing devices, including to the computing device 102. For example, the online marketplace 112 may generate listings 114 for items 116 for sale and expose those listings to computing devices, such that users of the computing devices can interact with the listings via user interfaces to initiate transactions (e.g., purchases, add to wish lists, share, and so on) in relation to the respective item 116 or items 116 of the listings. In accordance with the described techniques, the items 116 include one or more types of physical goods or property (e.g., clothing and/or clothing accessories, jewelry, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the environment 100, the online marketplace 112 includes a storage device 118, which is depicted as maintaining real-time listing data 120. The real-time listing data 120 includes a plurality of listings 114 of the online marketplace 112. The storage device 118 may represent one or more databases and/or other types of storage capable of storing the real-time listing data 120. Examples of the storage device 118 include, but are not limited to, mass storage and virtual storage. In one or more implementations, for example, the storage device 118 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account. In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items 116 listed with the online marketplace 112 (e.g., the items 116 that those users decide to list through the online marketplace 112) than the company associated with the online marketplace 112 (or its employees or agents).

Users that cause items 116 to be listed on the online marketplace 112 may be referred to as “sellers,” whereas users that purchase or otherwise obtain items 116 listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items 116 to be listed on the online marketplace 112 and by interacting with the user interfaces to purchase one or more items 116 from the listings of the online marketplace 112.

A user that is a seller, for instance, may interact with one or more user interfaces of the online marketplace 112 (e.g., output via the application 110) to provide information about one or more items 116 which the user is causing to be listed on the online marketplace 112. Such user interfaces may include prompts that instruct, or guide, users that are sellers to provide various information about items 116 being listed. Examples of information that such interfaces prompt sellers for and that those users provide include, but are not limited to, a title, description (of the item 116), one or more prices (e.g., to purchase the item 116 now and/or a minimum starting bid for the item 116), brand information, size, year, color(s), shipping information (e.g., cost and/or types available), delivery information, return information, payment information, images, videos, models, authenticity information, item history (e.g., chain of custody), and condition (of the item 116), to name a few.

One or more portions of such information may be referred to herein as attributes 122 of the listing 114. For example, a title of the listing 114 may be an attribute 122 of the listing, a description of the item 116 being listed may be an attribute 122 of the listing 114, one or more images uploaded or selected for the listing 114 may be one or more attributes 122 of the listing 114, color(s) of the item 116 may be an attribute 122 of the listing 114, one or more categories 124 (e.g., product or item classes) of the item 116 may be attributes 122 of the listing 114, and so forth. The categories 124 may provide a way to organize inventory of the online marketplace.

In one or more implementations, the categories 124 of the online marketplace 112 include a category hierarchy (e.g., a tree structure) in which more specific child categories 124 (e.g., smartphones) fall under more generic parent categories 124, e.g., electronics. Additionally, or alternatively, the categories 124 of the online marketplace 112 include a plurality of sector categories 124 (e.g., sports) each including one or more highest-level or root categories 124 (e.g., sports memorabilia, sporting goods). Given this, the categories 124 associated with a listing 114 for an item 116 can include the categories 124 of the category hierarchy that the item 116 falls under (e.g., from the root category 124 to the lowest-level or leaf category 124), and one or more sector categories 124 to which the item 116 belongs.

In one or more implementations, the online marketplace 112 saves and maintains the input information for a listing 114 in the storage device 118 in fields of a data structure or data record populated for the listing 114, where a given field and the information populated and maintained for the given field correspond to a particular attribute 122 of the listing 114. For instance, a ‘title’ field of such a data structure or data record may be populated with information (e.g., text) input into a user interface by a seller of a listing 114. The title field and the information input by the user as the title of the listing 114 correspond to an attribute 122 of the listing 114, e.g., a title attribute. In one or more implementations, one or more of the attributes 122 of a listing 114 may be derived and then populated by the online marketplace 112, such as by the online marketplace 112 processing one or more portions of the information input by a user to populate one or more respective attributes of the listing 114.

The search platform 106 may support an LLM 132. The LLM 132 may be an example of a multi-modal model, which may be capable of processing different types of data (e.g., text, images, videos, audio) simultaneously, or other types of generative AI models. The LLM 132 may be trained on the real-time listing data 120 of any listing 114 on the online marketplace 112.

Users (e.g., buyers) may utilize the search platform 106 to search for items 116 they may decide to purchase. The search platform 106 may include a search field in which a buyer may input a search query 126. The search query 126 may include keywords or a longer string related to an item 116 the buyer is looking for. For example, the search query 126 may be a keyword such as “necklace,” which is a relatively broad search, or the search query 126 may be a string “14K gold necklace with diamonds,” which may be a more specific search.

The search platform 106 may output search results 128 based on the search query. The search results 128 may include a list of listings 114 that correspond to the search string “14K gold necklace with diamonds,” for example. The search results 128 may be generated by the search platform 106 based on tags associated with the listings 114. For example, if the phrase “14K gold necklace with diamonds” or any individual word in the phrase (e.g., “14K,” “gold,” “necklace,” or “diamonds,” is included in the real-time listing data 120 for a given listing 114, then that listing 114 may be included in the search results. Additionally, or alternatively, the search results 128 may be generated based on attributes 122 or categories 124 that have been associated with keywords in the search query. For example, if the keyword “necklace” corresponds to a “jewelry” category 124, then the search results 128 may substantially include listings 114 in the “jewelry” category 124.

The search results 128 may be provided to the LLM 132. In some cases, particularly when the search query 126 is broad or generic, the search results 128 may include hundreds, thousands, or more listings 114. As it may be impossible for the buyer to review every one of these listings 114, the buyer may input a prompt 130 for the LLM 132. For example, the buyer may input the prompt 130 into a chat GUI that pops up in the same window as the search results 128, such that the user may query the LLM 132 through a chatbot or AI assistant.

The prompt 130 may be a question asking for more refined search results. That is, instead of relying on attribute-based filters (as since a seller may input incomplete listing data for any given listing 114), the buyer may ask the chatbot a question about a specific item 116 the buyer is looking for, and the chatbot may generate and display a subset of search results 134. For example, the prompt 130 may include a long-context input associated with the search results 128. In some implementations, the prompt 130 may include a request to filter the search results based on some attributes or criteria. Additionally, or alternatively, the prompt 130 may include a question regarding information associated with the one or more items that is excluded from one or more corresponding item listings as displayed, the information including a title, a description, pricing information, shipping information, and so on. In some examples, the prompt 130 may be associated with a portion of search results highlighted by a user. That is, the user may highlight the top ten listings presented to them and ask a specific question about those listings.

By way of example, the search query 126 “14K gold necklace with diamonds” may result in hundreds of thousands of listings 114. The user may ask the chatbot “which listings offer Priority Mail shipping?” and the chatbot may output the subset of search results 134, which may only include listings 114 from the search results 128 that offer Priority Mail shipping. The LLM 132 may retrieve such shipping information from the real-time listing data 120 even if the seller improperly included the shipping information. For example, if the seller failed to include shipping information in a specific shipping information field in the listing 114, but instead indicated that the seller offers Priority Mail shipping in a broader item description field, the LLM 132 may still recognize the shipping information.

In some examples, the subset of search results 134 may be displayed in a list format (e.g., the window showing the search results 128 may refresh and show the subset of search results 134). Alternatively, the subset of search results 134 may be highlighted other otherwise visually displayed to the buyer. In some examples, the buyer may highlight a specific listing 114 from the search results 128 and ask the chatbot to provide specific information for that listing 114.

Having considered an example of an environment, consider now a discussion of some example details of the techniques for using AI-based search results in accordance with one or more implementations.

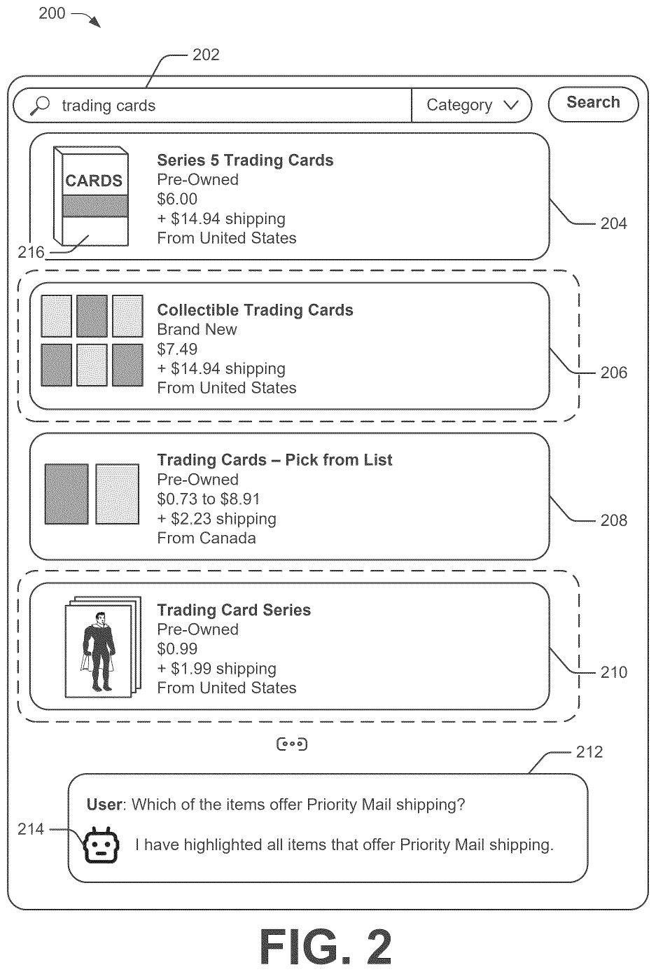

FIG. 2 depicts an example of an search platform 200 for generating AI-based search results in accordance with aspects of the present disclosure. The search platform 200 may be implemented in or otherwise supported by the computing device 102, the service provider system 104, for example, as the search platform 106, as described with reference to FIG. 1.

Users (e.g., buyers) may utilize the search platform 200 to search for items they may decide to purchase on an online marketplace. The search platform 200 may include a search field 202 in which a user may input a search query, which may include keywords or a longer string such as “trading cards.” In some examples, the user may search for trading cards within a specific category of items sold on the online marketplace, which the user may select via a drop-down menu in the search field 202. For example, the user may search for trading cards across all categories of the online marketplace of just within a specific category, such as collectibles or toys and hobbies. The user may execute the search by clicking a “search” button.

In some examples, the search platform 200 may output search results, which may include numerous listings that correspond to the search query. For example, the search results may include a listing 204, a listing 206, a listing 208, a listing 210, and so forth, which may be examples of listings 114. Each of these listings may related to the search for trading cards and may include general information about that listing, when displayed to the user. By way of example, the listings may each display a title of the listing (e.g., Series 5 Trading Cards, Collectible Trading Cards, Trading Cards Pick from List, Trading Card Series), a condition (e.g., Brand New, Pre-Owned, Used, and so forth), an item price and a shipping price (e.g., $6.00+$14.94 shipping, $7.49+$14.94 shipping, $0.73 to $8.91+$2.23 shipping, $0.99+$1.99 shipping), and a shipping origin (e.g., from United States, from Canada, and so forth). Once the user selects a listing and opens the listing in a new tab, the user may be able to view additional information about the item. For example, the listing may include information such as item number, title, start price, vertical category, item site (e.g., United States), item description, item aspects (e.g., size dimensions, weight, features, etc.), category breadcrumb, item condition, item location, item identifier (ID), and so forth.

The search results may be provided to an LLM or other AI model, which may be the foundation for an AI assistant 212. The LLM may use a combination of learned knowledge and in-context learning to provide outputs to users via the AI assistant 212. The LLM may acquire learned knowledge as the LLM is trained on data associated with e-commerce domain, including real-time listing data for any listing on the online marketplace, a seller profile corresponding to sellers of specific items, shipping procedures, image data, specifications corresponding to an item number, and so forth. The LLM may also utilize in-context learning by processing the provided search results. In this way, the LLM may process long-context inputs from a user. When the LLM is provided the search results (with long-context size), the LLM may be capable of processing attributes of the items included in the search results, including titles, aspects, descriptions, images, and so forth.

In some cases, the user may be interested in information that is not directly shown in the listings 204, 206, 208, and 210, but rather in an item description or another field of a listing once opened in a new tab or window. Instead of having to open every individual listing, which is impractical given there may be hundreds or thousands of listings in the search results, the user may provide a prompt (e.g., a long-context input) for the LLM via the AI assistant 212. The prompt may be a question about the information the user is seeking (but that is not shown in the current view of the search platform 200). For example, the user may input the prompt: “Which of the items offer Priority Mail shipping?” where the seller excluded such shipping information from the listing as it is displayed to the user.

Based on the search results and the item listing data on which the LLM is trained, the LLM may execute to generate a subset of original search results and output the subset to the user. For example, the LLM may output the subset of search results (e.g., a smaller set of listings) via a chatbot 214 of the AI assistant. In some examples, the chatbot 214 may indicate a list of items or listings that satisfy the user's prompt (e.g., listings that offer Priority Mail shipping). Alternatively, the chatbot 214 may indicate that the subset of search results are highlighted or otherwise noted in the original search results. For example, the chatbot 214 may respond to the user: “I have highlighted all items that offer Priority Mail shipping,” where the listing 206 and the listing 210 may be highlighted (e.g., item descriptions of these listings may indicate that priority shipping is offered). The user may then open those specific listings to ascertain more information rather than opening up all the listings included in the original search results.

By way of another example, the user may select or highlight a specific listing (e.g., the listing 204) and ask the chatbot 214 questions about that specific listing. For example, to ask whether an image in an item listing is an accurate representation of the actual item the user would receive if purchased, the user may input a prompt such as: is the picture from the from the actual item?” That is, the user may ask if an image 216 displayed as part of the listing 204 is an image the seller took of the actual, physical item that is posted for sale, or of the image 216 is a stock image (e.g., from a website originally selling that item). The chatbot 214 may respond to the user: “no, according to the description it is a stock image.” That is, the LLM may utilize the search results and training data to obtain information from within the listing 204 without the user opening and reviewing the listing 204 in a new tab or window themselves.

By way of another example, the user may highlight a specific listing (e.g., the listing 208 and ask the chatbot 214:“Can this item be shipped to Germany?” Based on execution of the LLM, the chatbot 214 may respond to the user: “yes, it will be shipped via a Global Shipping Program.” That is, the LLM may know whether the item may be shipped to Germany based on global shipping data. By way of another example, the user may ask the chatbot 214:“is this the earliest set of Magic Cards deck that I can purchase?” and “what are the IDs of items from Professional Sports Authenticator (PSA) card grading company?” By asking these types of questions, the user may quickly learn information about different listings using the AI assistant 212 without clicking through descriptions of various items and looking up external sources to determine answers the user would like before committing to a purchase.

By way of another example, the user may ask the chatbot 214 to highlight or otherwise indicate listings that fulfill some criteria. For example, the user may input the keywords “flower pots” in the search field 202, receive initial search results, and ask the chatbot: “Please highlight the flower pots that have an unusual or funny design.” Based on execution of the LLM, the chatbot 214 may respond to the user: “I have highlighted all items with an unusual or funny design.”

The user may input additional questions into the AI assistant 212, where the output results may be reset with each search. For example, after the user asks, “which of the items offer Priority Mail shipping,” which resulted in the highlighting of the listing 206 and the listing 210, the user may ask a different, unrelated question, at which point the highlighting may be removed. Alternatively, the user may input a prompt to further refine results previously-generated by the LLM and output by the chatbot 214.

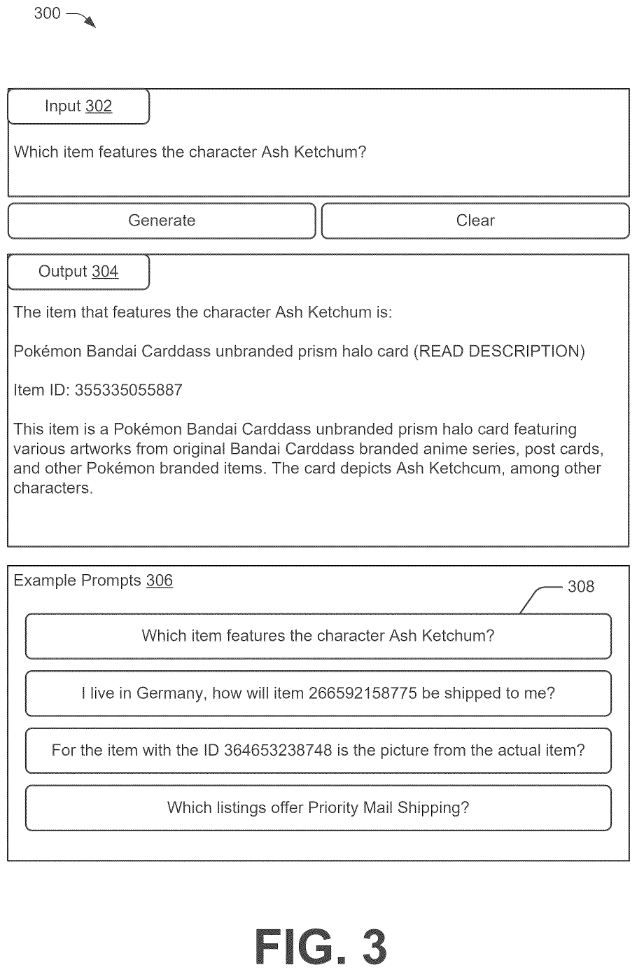

FIG. 3 depicts an example of a user interface 300 for AI-based search results in accordance with aspects of the present disclosure. The user interface 300 may be implemented in a search platform 106 or a search platform 200, described herein with reference to FIGS. 1 and 2. For example, the user interface 300 may support an AI assistant that enables a user (e.g., a buyer) to ask questions about item listings when searching for an item on an online marketplace. In some examples, the user may interact with the AI assistant via the user interface 300 through a chatbot.

The user interface 300 may include an input 302, a field in which the user may input a prompt or question for an LLM. Additionally, the user interface 300 may include an output 304, a field in which the AI assistant (e.g., a chatbot) may output results generated by the LLM based on the user's prompt. The user interface 300 may also include example prompts 306 which the user may reference when inputting their own prompts.

The user interface 300 may correspond to the search for “trading cards” described herein with reference to FIG. 3. After inputting keywords “trading cards” into a search field on an online marketplace, the search platform may display a set of search results including numerous listings for trading cards. The user may be looking for a specific trading card, so the user may use the input 302 to ask: “Which item features the character Ash Ketchum?” The user may select a “generate” button to execute the LLM based on this question, or the user may select a “clear” button to erase the question so the user may input something else.

The LLM may go through all of the item listings included in the search results to determine which one or more items feature the character, Ash Ketchum, and the output 304 may display the results of executing the LLM to the user. For example, the output 304 may state “The item that features the character Ash Ketchum is: Pokémon Bandai Carddass unbranded prism halo card (READ DESCRIPTION).” In some examples, the output 304 may also indicate an Item ID corresponding to a specific item (e.g., 355335055887) and an explanation as to why the LLM is indicating that specific item, such as: This item is a Pokémon Bandai Carddass unbranded prism halo card featuring various artworks from original Bandai Carddass branded anime series, post cards, and other Pokémon branded items. The card depicts Ash Ketchcum, among other characters.” The LLM may output this information based on the initial search results and the context on which the LLM is trained (e.g., item descriptions and other information included in listings).

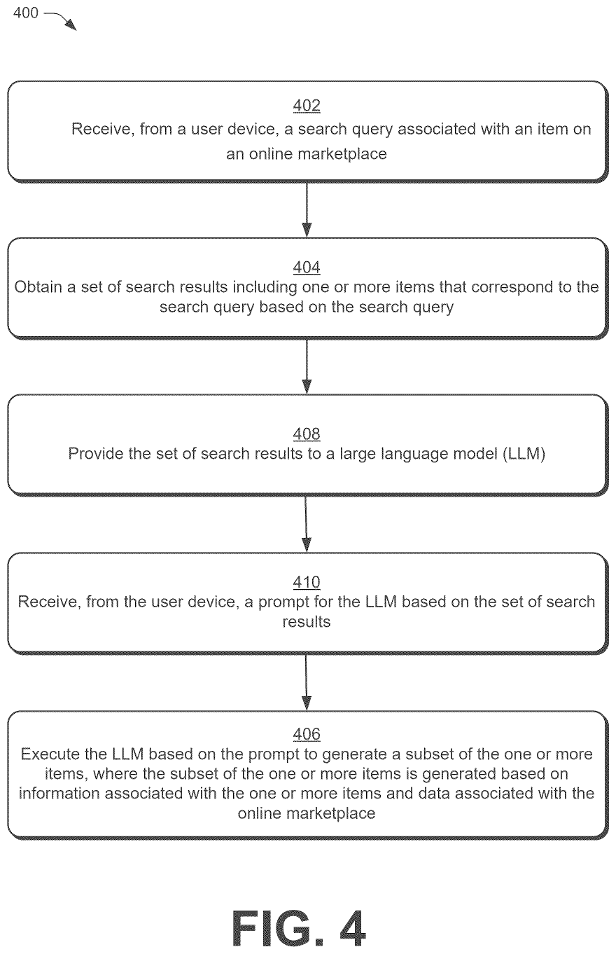

The user may input any prompt or question independently, or the user may use one of the example prompts 306. For example, the input 302 is a question 308 provided in the example prompts 306. The example prompts 306 may be generated (e.g., by the LLM) based on the user's original search query (e.g., trading cards). In the example of FIG. 4, other example prompts 306 may include “I live in Germany, how will item 266592158775 be shipped to me?” “For the item with the ID 364653238748 is the picture from the actual item?” and “Which listings offer Priority Mail Shipping?” among other examples questions.

In some implementations, the user may provide user feedback data to improve the LLM. For example, if the item in the output 304 (corresponding to item ID 355335055887) does not feature the character Ash Ketchum, then the user may indicate that to the system to further train the model. Alternatively, the user may confirm that the item did in fact feature the character Ash Ketchum. The user may provide the feedback and the LLM may generate additional outputs (e.g., other subsets of the original search results) based on the feedback.

Having discussed exemplary details of generating AI-based search results, consider now some examples of procedures to illustrate additional aspects of the techniques.

This section describes examples of procedures for AI-based search results for an online marketplace. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 4 depicts a procedure 400 in an example implementation of AI-based search results in accordance with aspects of the present disclosure.

A search query associated with an item on an online marketplace is received from a user device (block 402). By way of example, a user (e.g., buyer) may search for an item 116 for sale in an online marketplace 112 by inputting a search query 126 (e.g., a keyword) into a search field.

A set of search results including one or more items that correspond to the search query based on the search query are obtained (block 404). By way of example, the online marketplace 112 may present search results 128 to the user, which may include listings 114 that correspond to the search query 126.

The set of search results are provided to an LLM (block 406). By way of example, the search results 128 are provided to an LLM 132 as in-context learning data, where the LLM 132 is trained on data associated with the e-commerce domain (e.g., item descriptions and other listing information available on the online marketplace).

A prompt for the LLM is received from the user device based on the set of search results (block 408). By way of example, a user may input a prompt 130 to ask a question about the search results 128. For example, the prompt 130 may include a question about shipping information, specific features of an item 116, and the like.

The LLM is executed based on the prompt to generate a subset of the one or more items, where the subset of the one or more items is generated based on information associated with the one or more items and data associated with the online marketplace (block 410). By way of example, the LLM 132 may generate and output one or more listings that satisfy the user's prompt 130. In some examples, the LLM 132 may output a list of the listings. Additionally, or alternatively, the LLM 132 may highlight items that satisfy the user's prompt 130.

Having described examples of procedures in accordance with one or more implementations, consider now an example of a system and device that can be utilized to implement the various techniques described herein.

FIG. 5 illustrates an example of a system 500 generally that includes an example of a computing device 502 that is representative of one or more computing systems and/or devices that may implement the various techniques described herein. This is illustrated through inclusion of the application 110 and the search platform 106. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.” “Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer. “Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, from a user device, a search query associated with an item on an online marketplace;
obtaining a set of search results including one or more items that correspond to the search query based on the search query;
providing the set of search results to a large language model (LLM);
receiving, from the user device, a prompt for the LLM based on the set of search results; and
executing the LLM based on the prompt to generate a subset of the one or more items, wherein the subset of the one or more items is generated based on information associated with the one or more items and data associated with the online marketplace.

2. The computer-implemented method of claim 1, wherein the prompt comprises a long-context input associated with the set of search results.

3. The computer-implemented method of claim 1, wherein the prompt comprises a request to filter the one or more items based on one or more attributes, and wherein the subset of the one or more items is generated based on the request.

4. The computer-implemented method of claim 1, wherein the prompt comprises a question regarding information associated with the one or more items that is excluded from one or more corresponding item listings, wherein the subset of the one or more items is generated based on the question.

5. The computer-implemented method of claim 1, wherein the information associated with the one or more items comprises one or more item listings corresponding to the one or more items, an item listing comprising at least one of a title, a description, pricing information, and shipping information.

6. The computer-implemented method of claim 1, wherein the data associated with the online marketplace comprises at least one of shipping procedures, image data, or specifications corresponding to an item number.

7. The computer-implemented method of claim 1, further comprising:
providing one or more example prompts based on the search query, wherein the prompt is selected from the one or more example prompts.

8. The computer-implemented method of claim 1, further comprising:
displaying, via a user interface of the user device, the subset of the one or more items, wherein displaying the subset of the one or more items comprises highlighting the subset of the one or more items or outputting a list of the subset of the one or more items.

9. The computer-implemented method of claim 1, wherein the prompt is associated with a portion of the set of search results highlighted by a user of the user device.

10. The computer-implemented method of claim 1, further comprising:
receiving, from the user device, feedback associated with the subset of the one or more items; and
generating a second subset of the one or more items based on the feedback.

11. The computer-implemented method of claim 1, wherein the LLM is a multi-modal LLM with at least a text-analysis capability and an image-analysis capability.

12. A system comprising:
one or more processors; and
memory storing instructions that, when executed by the one or more processors, cause the system to:
receive, from a user device, a search query associated with an item on an online marketplace;
obtain a set of search results including one or more items that correspond to the search query based on the search query;
provide the set of search results to a large language model (LLM);
receive, from the user device, a prompt for the LLM based on the set of search results; and
execute the LLM based on the prompt to generate a subset of the one or more items, wherein the subset of the one or more items is generated based on information associated with the one or more items and data associated with the online marketplace.

13. The system of claim 12, wherein the prompt comprises a long-context input associated with the set of search results.

14. The system of claim 12, wherein the prompt comprises a request to filter the one or more items based on one or more attributes, and wherein the subset of the one or more items is generated based on the request.

15. The system of claim 12, wherein the prompt comprises a question regarding information associated with the one or more items that is excluded from one or more corresponding item listings, wherein the subset of the one or more items is generated based on the question.

16. The system of claim 12, wherein the information associated with the one or more items comprises one or more item listings corresponding to the one or more items, an item listing comprising at least one of a title, a description, pricing information, and shipping information.

17. The system of claim 12, wherein the data associated with the online marketplace comprises at least one of shipping procedures, image data, or specifications corresponding to an item number.

18. The system of claim 12, wherein the instructions further cause the system to:
provide one or more example prompts based on the search query, wherein the prompt is selected from the one or more example prompts.

19. The system of claim 12, wherein the instructions further cause the system to:
display, via a user interface of the user device, the subset of the one or more items, wherein displaying the subset of the one or more items comprises highlighting the subset of the one or more items or outputting a list of the subset of the one or more items.

20. A non-transitory computer-readable media storing instructions that, when executed by one or more processors, cause the one or more processors to perform operations including:
receiving, from a user device, a search query associated with an item on an online marketplace;
obtaining a set of search results including one or more items that correspond to the search query based on the search query;
providing the set of search results to a large language model (LLM);
receiving, from the user device, a prompt for the LLM based on the set of search results; and
executing the LLM based on the prompt to generate a subset of the one or more items, wherein the subset of the one or more items is generated based on information associated with the one or more items and data associated with the online marketplace.
